(19) United States
(12) Patent Application Publication
(10) Pub. No.: US 2002/0000041 A1
(43) Pub. Date: Jan. 3, 2002

(54) Disposable razor wear indicator

(76) Inventor: Siamak Doroodian-Shoja, Needham, MA (US)

Correspondence Address: FOLEY, HOAG & ELIOT, LLP, PATENT GROUP, ONE POST OFFICE SQUARE, BOSTON, MA, 02109, US

(21) Appl. No.: 09/904,447

(22) Filed: Jul. 12, 2001

Related U.S. Application Data
(63) Continuation of application No. 09/024,371, filed on Feb. 12, 1998, now abandoned.
Application No. 09/024,371 is a continuation of application No. 08/741,637, filed on Oct. 28, 1996, now abandoned.
Application No. 08/741,637 is a continuation of application No. 08/365,757, filed on Dec. 29, 1994, now abandoned.
Application No. 08/365,757 is a continuation-in-part of application No. 08/188,244, filed on Jan. 28, 1994, now Pat. No. 5,388,331.

(51) Int. Cl. B26B 21/40

(52) U.S. Cl. 30/41.7; 30/34.05

(57) ABSTRACT

Wear indicating means are located on the head or frame of a disposable razor or razor cartridge, in close proximity to the shaving edge of the blade. The wear indicating mans comprises a mass of material that gradually wears away as the disposable razor or cartridge is used in shaving, the amount of material wearing away being correlated with the amount of wear on the blade edge to provide a visual indication of the relative wear on the blade. Preferably, letters or indicia are provided on the head or frame and are covered with said material, the letters or indicia being revealed as the material is worn away during shaving. The letters or other indicia may be printed or painted directly on the frame, or may be provided as raised protrusions or as depressions formed in the frame. Alternatively, the wear indicating means may comprise a strip of material formed of two contrastingly-colored layers, each being wedge-shaped and facing opposite directions, so that increasingly more of the lower layer is revealed as the strip is worn away. Markers may be provided on the frame or head adjacent the strip to cooperate with the strip to provide a visual indication of the relative wear on the blade. Alternatively, a layer of material of uniform thickness may be provided between two wedge-shaped layers, said middle layer being of a color contrasting with the color of the other two layers, so that as the strip is worn away, the revealed edge of the middle layer appears to move horizontally along the strip.

This application is a continuation-in-part of application Ser. No. 08/188,244, filed on Jan. 28, 1994.

### BACKGROUND OF THE INVENTION

This invention relates to disposable razors, and particularly to visual means for readily indicating to the user the relative amount of wear that the blade of a given disposable razor has undergone.

Disposable razors have seemingly become increasingly popular because of their ease of use and the lack of care and maintenance they require. Generally, disposable razors comprise a plastic handle and a frame or head, in which frame or head one or more shaving blades are mounted. Alternatively, for purposes of this application, the term “disposable razor” is also intended to include a razor blade mounted in a “cartridge,” for fitting into a non-disposable handle, the cartridge itself being disposable.

The blade edge of a disposable razor gradually wears down with use, until at some point the user decides to discard the razor. For each individual shaver, the number of shaves that he or she will enjoy from a particular disposable razor is to some extent a matter of individual choice. An individual will make a subjective judgment—based upon how the blade feels on the skin during the shaving stroke, or perhaps on other grounds—that it is time to dispose of that particular razor and begin to use a new one. Visual inspection of the blade edge itself usually yields little or no information as to how worn the blade has become.

It is believed that the typical user of a disposable razor would benefit from the inclusion of some reliable, and easily recognizable, visual indicator of the relative amount of wear that a particular disposable razor blade has undergone. With such a visual indication, a shaver could make a subjective judgment as to when to dispose of a particular razor. It would not be necessary to determine the amount of wear on the razor by the amount of pain or discomfort felt when the blade was used.

### OBJECTS OF THE INVENTION

It is an object of the present invention to provide an indicator means for a disposable razor that will present to the user a reliable visual indication of the relative wear of the razor blade.

It is a further object of the invention to provide an indicator means that is readily understandable and recognizable.

It is a still further object of the invention to provide such an indicator means that is inexpensive and simple to apply during the manufacturing process.

### SUMMARY OF THE INVENTION

This invention comprises a mass of contrastingly-colored material applied to the frame or head of a disposable razor adjacent the blade, the mass of material being so chosen in composition and dimension that its abrasion characteristics are appropriately correlated to the wear characteristics of the blade, as further explained below. The mass of material is located so that it is substantially constantly in direct contact with the skin during the shaving stroke, the material being abraded away by friction with the skin and hair. As the material is worn away, the shaver is given a visual indication of the relative wear on the razor blade.

In one preferred embodiment, letters or other indicia provided on the frame or head of the razor are covered by the mass of material, and then appear as the material is worn away during shaving. For example, an informative word such as “DISCARD” may be provided on the head or frame and made to appear after some number of shaves. Or letters or other indicia may be utilized in “lottery” fashion, such that prizes may be awarded to shavers lucky enough to find the winning combination of letters, numbers, or symbols, revealed on their used razors.

In a preferred embodiment, raised letters or other indicia are molded into or otherwise provided on the frame or head of the razor, and the mass of material is applied over said indicia, so that, as the contrastingly-colored material is worn away during shaving, the letters or indicia molded into the frame become visible. The mass of material may be in the form of a strip extending generally parallel to the shaving edge and covering said letters or other indicia, or it may comprise individual “spots” of material covering each individual letter or other indicium.

Alternatively, the letters or other indicia could be molded into or otherwise provided in the frame or head as depressions, with the mass of material applied over the depressions, so that as the material is worn away during shaving, the “sunken” letters or other indicia would remain filled with the material, while the contrastingly-colored portions of the frame or head surrounding the depressed letters or indicia would become visible.

In still another embodiment of the wear indicator means of the present invention, three layers of material in strip form are applied to the head or frame adjacent the shaving edge. The upper and lower layers are wedge-shaped in cross-section, varying in thickness along the length of the strip, the thinner end of the upper strip being applied above the thicker end of the lower strip. The middle layer is preferably a relatively thin, uniform layer, of a color contrasting with the upper and lower layers. As the upper layer is worn away during shaving, a portion of the middle layer is first exposed at the thinner end of the upper layer. As shaving continues, more of the upper and middle layers are worn away, and the lower layer is increasingly exposed, so that the exposed portion of the middle layer appears to move across the length of the strip. Markers may be molded or otherwise provided on the frame, to provide, in cooperation with the exposed portion of the middle layer, an indication of the amount of wear on the blade edge.

Alternatively, the middle layer may be eliminated altogether, as described in the parent patent application, and only two contrastingly-colored, wedge-shaped layers employed, so that, as the material of the upper layer is worn away, the contrasting color of the lower layer appears as a lengthening band. Again, markers molded or otherwise provided on the frame furnish a further indication of the amount of wear on the blade edge as the “band” of the exposed lower layer lengthens across the strip.

Other objects and features of the invention will be evident from the descriptions contained herein.

### BRIEF DESCRIPTION OF THE DRAWINGS

The invention will be further described with reference to the accompanying drawings, in which:

FIG. 1 is a perspective view of a disposable razor having mounted thereon, in close proximity to the blade edge, an indicator strip in accordance with the subject invention.

FIG. 2. is a perspective view of a disposable razor cartridge, in which the indicator strip of the invention has been worn away to reveal the word “DISPOSE” provided on the frame or head of the razor or cartridge.

FIG. 3 is a perspective view of a razor head having the word “DISCARD” in raised letters adjacent the shaving edge.

FIG. 4. is a perspective view of the razor head of FIG. 3 after the raised word “DISCARD” has been covered with the indicator strip, and after sufficient material from the strip has been worn away during shaving so that the word “DISCARD” has become visible through the remains of the indicator strip.

FIG. 5 is a perspective view of the razor head having the letter and numeral combination “074AB12” in depressed letters adjacent the shaving edge.

FIG. 6. is a perspective view of the razor head of FIG. 5 after the depressed numerals “074AB12” have been covered with the indicator strip, and after sufficient material from the strip has been worn away during shaving so that the letters and numerals “074AB12” have become visible against the contrastingly-colored frame or head.

FIGS. 7a through 7e depict the progressive wearing away of the three-layer strip of the current invention, as seen from the front edge view of the indicator means, beginning with an unused blade (FIG. 7a), and then proceeding, for the sake of example, through one, two, three, and four shaves (FIGS. 7b through 7e, respectively).

FIGS. 8a through 8e depict in top plan view the same indicator strip of FIGS. 7a through 7e as it is progressively worn away, the head or frame of the razor having markers adjacent the strip to provide an additional visual indication of the relative wear on the blade edge.

FIGS. 9a and 9b depict an indicator strip having only two contrastingly-colored layers forming the strip, first in an unused condition in FIG. 9a, and then after shaving in FIG. 9b.

FIGS. 10a through 10c depict various alternative sets of markers that may be used with the constructions of FIGS. 7 or 9.

FIG. 11 comprises a diagram illustrating a formula for determining the coefficient of wear for a given set of shaving parameters.

### DETAILED DESCRIPTION OF THE PREFERRED EMBODIMENT

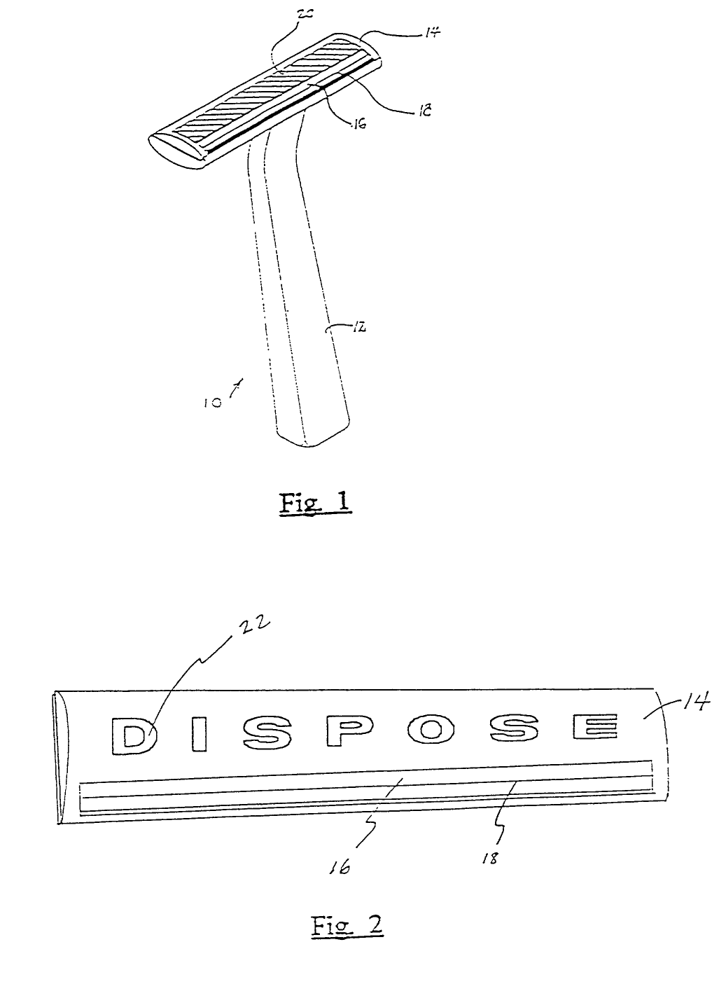

FIG. 1 depicts disposable razor 10, comprising a handle 12 and frame or head 14 affixed thereto. Mounted in head 14 is a single blade 16 having a shaving edge 18. As described in the parent of this application, wear indicating strip 20 extends generally parallel to, and in close proximity to, the shaving edge 18. Said wear indicating strip 20 is preferably located on the other side of the blade 16 from shaving edge 18, in order that said strip 20 contacts the skin after the blade has been stroked along the skin, thus minimizing the abrasive action on the strip. The strip should be so located that it is virtually constantly in contact with the skin and hair or beard during the shaving stroke.

Again as explained in the parent application, the wear indicating means could, of course, be of different dimension than that shown in FIG. 1—for example, not as long, or not as deep. Or it could be made of a series of small, discrete strips, or small circles, or various other geometrical configurations. In any case, during the shaving stroke, the wear indicating means will contact the skin and hair, thereby causing some of the material comprising the wear indicating means to be abraded away. By making the wear indicating means in a color that contrasts with the color of the razor head 14, the relative wear on the strip will be evident because the strip will be worn away, and the head will become visible. For example, a white strip on a blue razor head will gradually be worn away to reveal the blue color underneath.

The present invention provides letters 22 or other indicia on the head or frame of the razor itself, which letters or other indicia may then be covered with a single layer of material, and will then appear as the layer is worn away during shaving. FIG. 2 depicts such an arrangement, in which the word “DISCARD” is printed, painted, or otherwise provided on the surface of the head or frame 14. Alternatively, other words of indicia (such as diagonal stripes or a row of stars) could be made to appear as the upper layer is worn away.

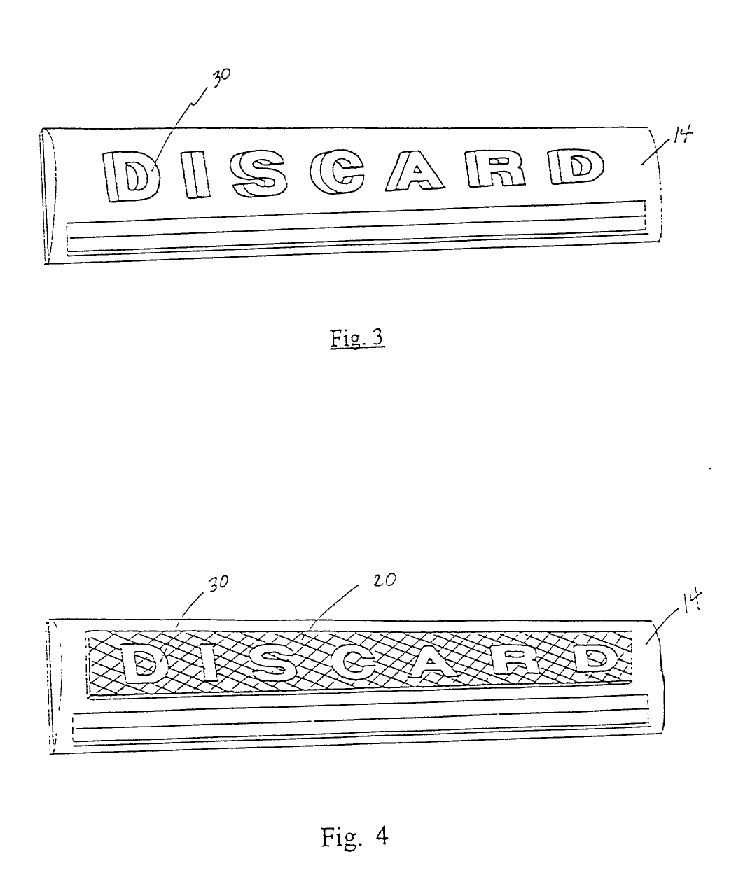

As shown in FIG. 3, the letters or other indicia 30 may be molded into or otherwise provided on the frame or head as raised protrusions. These raised protrusions would then be covered over with the material that is to be worn away. The material may be applied in strip form, as shown, or alternatively may be applied as a series of “spots,” each spot covering one of the individual letters or other indicia. As shown in FIG. 4, as the material 20, is worn away, the raised letters 30 are exposed to give the shaver a visual indication of the relative wear on the blade edge. The desired height of these protrusions depends, in part, on the thickness of the layer of wear indicating material. It is suggested that these protrusions rise above the surface for a distance of about half the thickness of the wear indicating material. Determination of the appropriate thickness for the wear-indicating material is discussed below.

In another alternative embodiment, as shown in FIG. 5, letters or other indicia 50 are molded into or otherwise provided on the frame or head as depressions, which are then covered and filled with the material. The material may be applied in the form of a strip, as previously shown, or in the form of individual “spots” covering each of the letters or other indicia. As the material is worn away during shaving, the contrasting color of the frame or head 14 becomes visible in the vicinity of the depressed letters or indicia, while the depressions remain filled with contrastingly-colored material 20, as shown in FIG. 6, informing the shaver that it may be time to discard the razor. The appropriate depth for the depressions is to some extent a function of the material used for the wear indicating means, but it is believed that a depth of 1/32 inch would be appropriate in many cases.

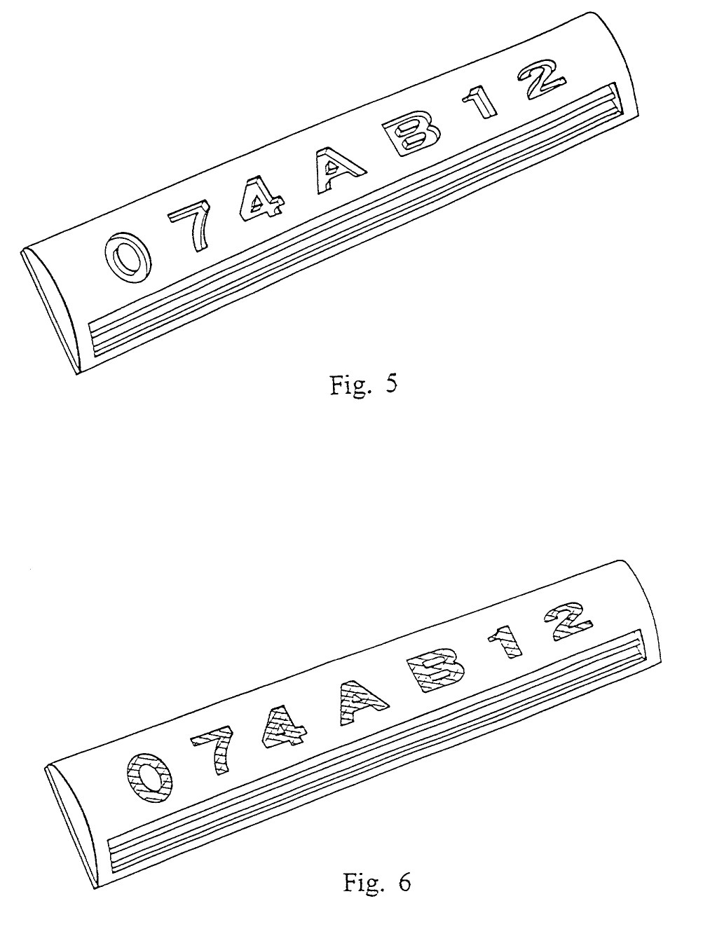

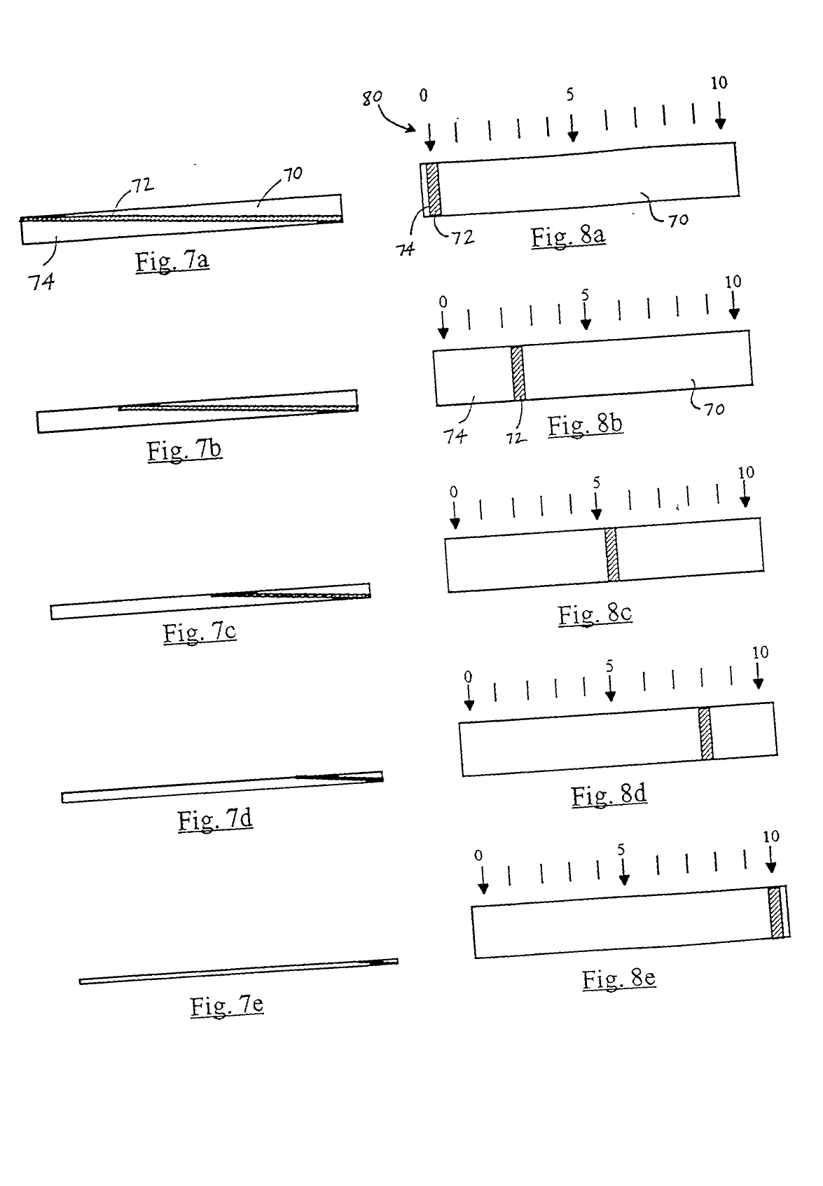

Another embodiment of the wear indicator means of the present invention is depicted in FIGS. 7a through 7e, in which three layers of material in strip form are applied to the head or frame adjacent the shaving edge. The upper and lower layers 70, 74 are wedge-shaped in cross-section, varying in thickness along the length of the strip, and of substantially the same dimensions. These two layers face in opposite directions, the thinner end of the upper strip being applied above the thicker end of the lower strip. The middle layer 72 is preferably a relatively thin, uniform layer of a color contrasting with the upper and lower layers. As the upper layer 70 is worn away during shaving, a portion of the middle layer 72 is first exposed at the shallower end of the upper layer 70. As shaving continues, more of the upper and middle layers are worn away, and the lower layer is increasingly exposed, so that the exposed edge of the middle layer appears to move across the length of the strip, much as a vertical radio dial indicator may be seen to travel across a horizontal radio dial. (See FIGS. 8a through 8e). Markers 80 may be molded or otherwise provided on the frame, to provide, in cooperation with the exposed portion of the middle layer 72, an indication of the amount of wear on the blade edge.

FIGS. 7a through 7e depict the progressive wearing away of the three-layer strip of the current invention, as seen from the front edge view of the indicator means, beginning with an unused blade (FIG. 7a), and then proceeding through one, two, three, and four shaves (FIGS. 7b through 7e, respectively).

FIGS. 8a through 8e depict in top plan view the same indicator strip of FIGS. 7a through 7e, respectively, as the strip is progressively worn away, the head or frame of the razor having markers 80 adjacent the strip that cooperate with the strip as it is worn away to provide a further visual indication of the relative wear on the blade edge.

Alternatively, the middle layer may be eliminated altogether, and only two contrastingly colored, wedge-shaped layers employed, so that, as the material of the upper layer is worn away, the contrasting color of the lower layer appears as a lengthening or widening band. Again, markers molded or otherwise provided on the frame may provide an indication of the amount of wear on the blade edge as the “band” of the exposed lower layer lengthens across the strip.

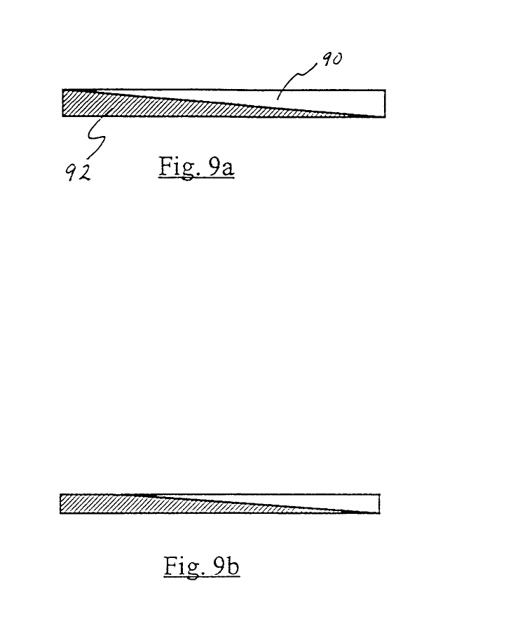

FIGS. 9a and 9b depict an arrangement like that of FIGS. 7a through 7e, but with only two contrastingly-colored layers 90, 92 forming the strip, beginning with an unused blade (FIG. 9a), and then proceeding through one shave (FIG. 9b).

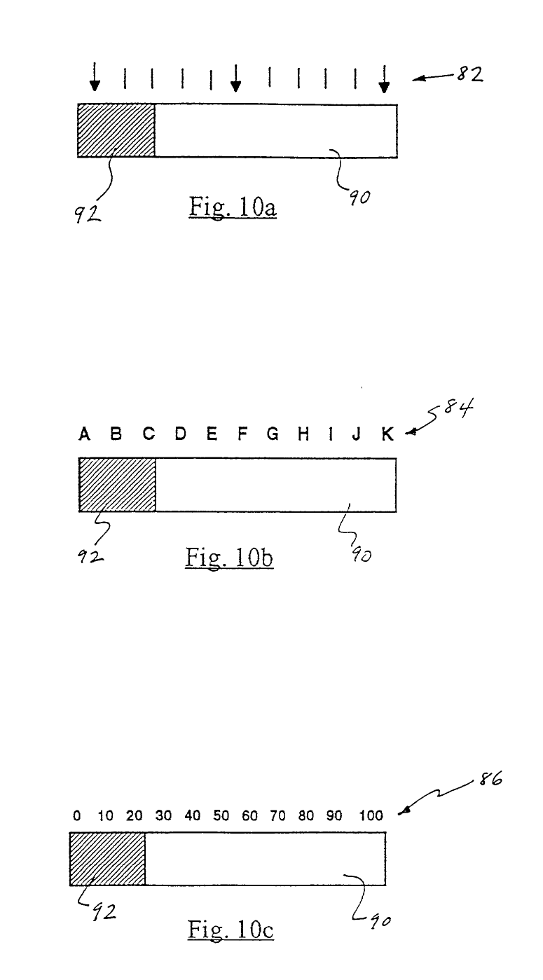

FIGS. 10a through 10c depict alternative sets of markers 82, 84, 86 that may be used with the constructions of FIGS. 7 or 9 (here shown in use with the two-layer configuration of FIG. 9). FIG. 10a shows a set of eleven equally-spaced markers 82 in the form of vertical lines, the end markers and the center marker being shaped as arrows. FIG. 10b shows a set of markers 84 comprising the letter “A” through “K”, equally spaced above the indicator strip. FIG. 10c depicts a set of markers 86 comprising a series of numerals “10, 10, 20, 30, 40, 50, 60, 70, 80, 90, 100” equally spaced above the strip. The markers may be provided on the frame or head by molding, printing, or any other suitable means. Of course, many other forms and types of markers could be provided, all within the scope of the present invention.

In using razors having a wear-indicating means according to the present invention, a shaver may, through his or her own experience, determine the particular point at which a razor should be discarded. This point obviously may differ for each individual shaver. For example, one shaver may find that the blade should be discarded when the letters or other indicia first become visible, while another may wait until the letters or other indicia are completely uncovered. Or, if markers accompany the strip, one shaver may determine that the razor should be discarded when a certain marker is reached, while another shaver may rely on another one of the markers as his or her signal. Thus If the wear-indicating means of the present invention is capable of being utilized on an individualized basis by each shaver, in order that the most comfortable amount of use may be enjoyed from each razor.

The wear-indicating material may be attached to the razor head or cartridge in many different ways. For example, a strip of material may be adhesively secured to the head or cartridge, or may be physically mounted and held in place thereon, by known methods. See, for example, the discussion in Booth U.S. Pat. No. 4,170,821.

The layer or layers of the indicator means may be constructed from numerous chemical combinations, but the following comprise the preferred materials. First, the layer or layers may be made out of soft, low density polymers such as polyethylene oxide and/or PTFE. For further details regarding the manipulation of the chemical properties of the layer materials to achieve the desired physical properties, see Fundamentals of Friction and Wear of Materials, 1980 ASM Materials Seminar, Pittsburgh, Pa., Daniel A. Rigney, ed., pp. 414-416. Color dyes should be chosen so as to meet applicable FDA requirements, and may be selected from Food and Color Additives Directory, published by Hazelton Laboratories, Inc., Falls Church, Va. Representative suitable food dyes or colorants are FD&C Red. No. 40, Erythrosine (FD&C Red No. 3), Brilliant Blue FCF (FD&C Blue No. 1), Indigotine (FD&C Blue No. 2), Tartrozine (FD&C Yellow No. 5), Sunset Yellow FCF (FD&C Yellow No. 6) and Fast Green FCF (FD&C Green No. 3). See also The Theory and Practice of Industrial Pharmacy, Second Edition, 1970, 1976, published by Lea & Febinger, pp. 331-332, for additional dyes and colorants that are acceptable.

Alternatively, should the layer or layers be constructed of microencapsulated material, the microcapsules may contain or be coated with dyes (as explained in The Theory and Practice of Industrial Pharmacy, supra, at pp. 420-427) and then mixed in a cement or binder such that the dyes in or on the microcapsules will be dispersed by pressure, shear stress, and/or abrasion.

As another alternative, the upper layer may be made from a dyed block of microencapsulated material adhered to a lower layer made from polymer such as polyethylene oxide, or vice versa.

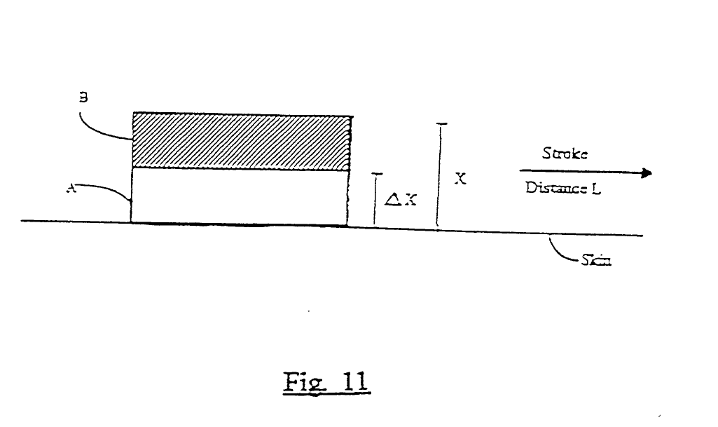

The choice of the material or materials to be employed for the wear-indicating means depends upon several factors, including the determination of how long a given blade will be or should be used by the shaver, and the approximate desired thickness of the indicator strip in the final product. FIG. 11 comprises a graphical illustration of the problem, in which A represents the upper layer of the indicator means—i.e., the layer or zone that contacts the skin. B represents the lower layer or zone of the indicator means—i.e. the layer closest to the head or cartridge of the razor. X is the total thickness of the indicator means prior to any shaving. L is the distance that the blade is stroked along the skin in a given shaving session. ΔX is the change in the thickness X resulting from stroking the razor blade over the skin for a distance L. Initially, of course, that change in thickness X occurs at the side of layer A that contacts the skin.

Assuming that the force of the stroke is constant for a given shaving session, it may be posited that ΔX is directly and linearly a function of the distance of the stroke L:

ΔX=μL

where μ can be denominated as the wear coefficient of the particular layer A of material. As a practical matter, a person with a relatively tougher hair or beard will need to stroke the razor more times during a shave, and thus more total distance L. If μ is a constant for the given layer material, then ΔX will be larger, since more wear will occur to the indicator strip as a result of the tougher hair or beard. Of course, those with softer hair or beards will require fewer strokes, and therefore L will be smaller, and so will ΔX.

I have found that, on the average, a man strokes the razor on his face a distance of about 100 inches to 300 inches during the course of a shave. Taking the average of 200 inches for the value of L, and assuming, for present purposes, that it is desirable that the lower layer be completely exposed after four shaves—i.e., that the razor should be discarded after four shaves—we may calculate the value of μ for a given thickness of material. For example if layer A is 1/32 inch thick, and L=4 shaves times 200 inches per shave=800 inches, then μ=3.906×10⁻⁵. Thus if one desires to make a two-layer indicator means with the lower layer being 1/32 inch thick, and one that will signal that the blade should be discarded after four shaves (on average), then one should choose a material having a wear coefficient μ of 3.906×10⁻⁵. The wear coefficients of different materials may be readily determined through experimentation, and thus a suitable material may be chosen for a given application.

An advantage of the subject invention is that the amount of wear undergone by strip itself is related to the “toughness” of the skin and hair being shaved—i.e., as stated above, “tough” hair will cause the indicator strip to wear away more rapidly than “soft” hair. At the same time, the blade itself will be subjected to more wear from the “tough” hair than the “soft” hair. Thus the amount of wear on the strip correlates well with the amount of wear on the blade.

It will be readily apparent to those skilled in the art that the present invention in its broader aspects is not limited to the specific embodiments herein shown and described. For example, instead of the visual indication of wear being provided by contrasting colors between the two layers of the strip, or between the strip and the frame or head, the visual indication could be a visually recognizable change in the texture of the indicator means, or a change in the size or geometry of the indicator means as portions are worn away.

Accordingly, variations may be made from the embodiments described herein which are within the scope of the accompanying claims, without departing from the principles of the invention and without sacrificing its chief advantages.

I claim:

1. In a disposable razor or razor cartridge comprising at least one blade mounted in a head or frame, said blade having a shaving edge, the improvement comprising letters or other indicia provided on the frame or head in close proximity to the shaving edge of the blade, each of said letters or other indicia being covered with a mass of material, said material gradually wearing away as the disposable razor or cartridge is used in shaving to expose said letters or other indicia.

2. The razor or cartridge of claim 1, wherein said frame or head is of a first color, and said material is of a second color contrasting with said first color.

3. The disposable razor or razor cartridge of claim 1, wherein the amount of material wearing away is correlated with the amount of wear on the shaving edge so as to provide a visual indication of the relative wear on the blade.

4. The disposable razor or razor cartridge of claim 1, wherein the letters or other indicia comprise raised protrusions formed on the head or frame.

5. The disposable razor or razor cartridge of claim 1, wherein the letters or other indicia comprise depressions formed in the head or frame.

6. In a disposable razor or razor cartridge comprising at least one blade mounted in a head or frame, said blade having a shaving edge, the improvement comprising wear indicating means for indicating the amount of wear on the shaving edge, said means being located on the head or frame in close proximity to the shaving edge of said blade, and said wear indicating means comprising a strip of material extending generally parallel to the shaving edge and gradually wearing away as the disposable razor or cartridge is used in shaving, said strip of material comprising a first substantially wedge-shaped layer affixed to the frame or head, a second layer of substantially uniform cross-section affixed atop said first layer, said second layer having an edge at the thicker end of said first layer, and a third wedge-shaped layer affixed atop said second layer and facing opposite said first layer, so that as said layers of material are gradually worn away during shaving, increasingly more of said first layer is uncovered, and said edge of said second layer appears to move across the strip beginning at the thicker end of the first layer and moving toward the thinner end of said first layer, thereby providing a visual indication of the relative wear on the blade.

7. The razor or cartridge of claim 6, wherein said second layer is of a color contrasting with the color or colors of the first and third layers.

8. The razor or cartridge of claim 7, wherein the frame or head is provided with markers spaced along said strip of material, said markers cooperating with said strip of material to provide a visual indication of the relative wear on the blade as increasingly more of the strip is worn away.

9. In a disposable razor or razor cartridge comprising at least one blade mounted in a head or frame, said blade having a shaving edge, the improvement comprising wear indicating means for indicating the amount of wear on the shaving edge, said wear indicating means being located on the head or frame in close proximity to the shaving edge of said blade, and said wear indicating means comprising a strip of material extending generally parallel to the shaving edge and gradually wearing away as the disposable razor or cartridge is used in shaving, said strip of material comprising a first substantially wedge-shaped layer affixed to the frame or head, and a second oppositely facing wedge-shaped layer affixed atop said first layer, so that as said second layer of material gradually wears away during shaving, increasingly more of the first layer is revealed, thereby providing a visual indication of the relative wear on the blade.

10. The razor or cartridge of claim 9, wherein said first layer is of a first color, and said second layer is of a color contrasting with said first color.

11. The razor or cartridge of claim 9, wherein the frame or head is provided with markers spaced along said strip of material, said markers cooperating with said strip of material to provide a visual indication of the relative wear on the blade as increasingly more of the first layer is worn away.
